(19) United States
(12) Patent Application Publication
(10) Pub. No.: US 2018/0005516 A1
(43) Pub. Date: Jan. 4, 2018

(54) ELECTRONIC SYSTEM, ELECTRONIC DEVICE AND CONTROLLING METHOD THEREOF

(71) Applicant: SAMSUNG ELECTRONICS CO., LTD., Suwon-si (KR)

(72) Inventors: Soo-hong KIM, Seoul (KR); Seok-hun KANG, Suwon-si (KR)

(73) Assignee: SAMSUNG ELECTRONICS CO., LTD., Suwon-si (KR)

(21) Appl. No.: 15/445,074

(22) Filed: Feb. 28, 2017

(30) Foreign Application Priority Data
Jul. 4, 2016 (KR) 10-2016-0084300

(51) Int. Cl. G08C 17/02; G08C 23/04; G08C 23/06

(52) U.S. Cl. CPC G08C 17/02; G08C 23/06; G08C 23/04; G08C 2201/92; G08C 2201/93; G08C 2201/40

(57) ABSTRACT

An electronic system, an electronic device, and a controlling method thereof are provided. The electronic device includes a first communication interface configured to establish connection between the electronic device and an interface device for interfacing with an external peripheral device, a second communication interface configured to receive a remote control signal for controlling the external peripheral device from a remote control device, and a process configured to, in response to the remote control signal at a carrier frequency being received from the remote control device via the second communication interface, control the first communication interface to transmit the received remote control signal at the carrier frequency to the interface device.

### CROSS-REFERENCE TO RELATED APPLICATIONS

This application claims priority from Korean Patent Application No. 10-2016-0084300, filed on Jul. 4, 2016 in the Korean Intellectual Property Office, the disclosure of which is incorporated herein by reference in its entirety.

### BACKGROUND

### 1. Field

Systems, apparatuses and methods consistent with exemplary embodiments relate to an electronic system, an electronic device, and a controlling method thereof, and more particularly, to an electronic system for transmitting signals to an external peripheral device via an interface device, an electronic device, and a controlling method thereof.

### 2. Description of the Related Art

Various electronic devices are being developed as technology advances. An electronic device may perform functions alone, or it may be connected to other peripheral devices to perform additional functions. For example, the primary function of a television (TV) may be to receive a broadcast signal and display a broadcast program. However, the TV may be connected to a set-top box to display various broadcast signals received from the set-top box. Alternatively, the TV may be connected to a video gaming console to display a game screen executed in the gaming console. Alternatively, the TV may be connected to a notebook personal computer (PC) to display the screen of the notebook PC.

On the other hand, electronic devices are having increasingly slimmer form factors and are being developed more with a design aesthetic in mind. Accordingly, remote interface device separate from the electronic device is sometimes adopted, and the interface device may include an input/output terminal of the electronic device. The interface device and the peripheral device may be located a certain distance from the electronic device and may be placed or built inside home furniture to blend into the environment within the home. Generally, a user needs to be in front of an electronic device to use a remote control device to control electronic devices, peripheral devices, and the like. It can be inconvenient for the user to remember the storage location of the peripheral device in order to control the peripheral device which is separated by a certain distance and to input the command by using the remote control device toward the peripheral device. If the peripheral device is located far away or inside the furniture, the peripheral device may not receive the input signal.

### SUMMARY

One or more exemplary embodiments may overcome the above disadvantages and other disadvantages not described above. Also, the present disclosure is not required to overcome the disadvantages described above, and an exemplary embodiment may not overcome any of the problems described above.

Exemplary embodiments provide an electronic system capable of operating without malfunction even when a control signal is output toward an electronic device regardless of the position of the peripheral device, an electronic device, and a controlling method.

According to an aspect of an exemplary embodiment, there is provided an electronic device including a first communication interface configured to connect the electronic device to an interface device for interfacing with an external peripheral device, a second communication interface configured to receive a remote control signal for controlling the external peripheral device from a remote control device, and a processor configured to, in response to the remote control signal at a carrier frequency being received from the remote control device via the second communication interface, control the first communication interface to transmit the received remote control signal at the carrier frequency to the interface device.

According to an aspect of another exemplary embodiment, there is provided controlling method of an electronic device including connecting, via a first communication interface of the electronic device, the electronic device to an interface device for interfacing an external peripheral device, receiving, via a second communication interface of the electronic device, a remote control signal at a carrier frequency from a remote control device for controlling the external peripheral device, and transmitting the received remote control signal at the carrier frequency to the interface device via the first communication interface.

According to an aspect of another exemplary embodiment, there is provided an electronic system including an electronic device and an interface device configured to interface with the electronic device and an external peripheral device. The electronic device includes a first communication interface configured to connect the electronic device and the interface device, a second communication interface configured to receive, from a remote control device, a remote control signal for controlling the external peripheral, and a processor configured to, in response to the remote control signal at a carrier frequency being received from the remote control device via the second communication interface, control the first communication interface to transmit the received remote control signal at the carrier frequency to the interface device, wherein the interface device is further configured transmit the remote control signal received from the electronic device to the external peripheral device.

### BRIEF DESCRIPTION OF THE DRAWINGS

The above and other aspects will become more apparent by reference to exemplary embodiments thereof, which are illustrated in the appended drawings. Understanding that these drawings depict only exemplary embodiments of the disclosure and are not therefore to be considered to be limiting of the scope of the disclosure, the principles herein are described and explained with additional specificity and detail through the use of the accompanying drawings, in which:

FIG. 1 is a diagram illustrating an electronic system according to an exemplary embodiment;

FIG. 2 illustrates a block diagram of an electronic device according to an exemplary embodiment;

FIG. 3 is a block diagram illustrating an electronic system by blocks according to an exemplary embodiment;

FIG. 4 is a diagram illustrating a process of transmitting a remote control signal according to an exemplary embodiment;

FIG. 5 illustrates a multipath effect of a remote control signal according to an exemplary embodiment; and

FIG. 6 is a flowchart of an electronic device control method according to an exemplary embodiment.

### DETAILED DESCRIPTION

Hereinafter, exemplary embodiments will be explained in greater detail with reference to the accompanying drawings. The embodiments described herein can be variously modified. Specific embodiments are described in the drawings and may be described in detail in the detailed description. It should be understood, however, that the specific embodiments disclosed in the accompanying drawings are only intended to facilitate understanding of the various embodiments. Accordingly, it is to be understood that the technical idea is not limited by the specific embodiments disclosed in the accompanying drawings, but includes all equivalents or alternatives falling within the spirit and scope of the invention. In the following description, a detailed description of known functions and configurations incorporated herein will be omitted when it may make the subject matter of the present invention rather unclear.

The terms such as “first” and “second” used in various example embodiments may modify various elements regardless of an order and/or importance of the corresponding elements, and do not limit the corresponding elements. These terms may be used for the purpose of distinguishing one element from another element. It is to be understood that the singular forms “a,” “an,” and “the” include plural referents unless the context clearly dictates otherwise.

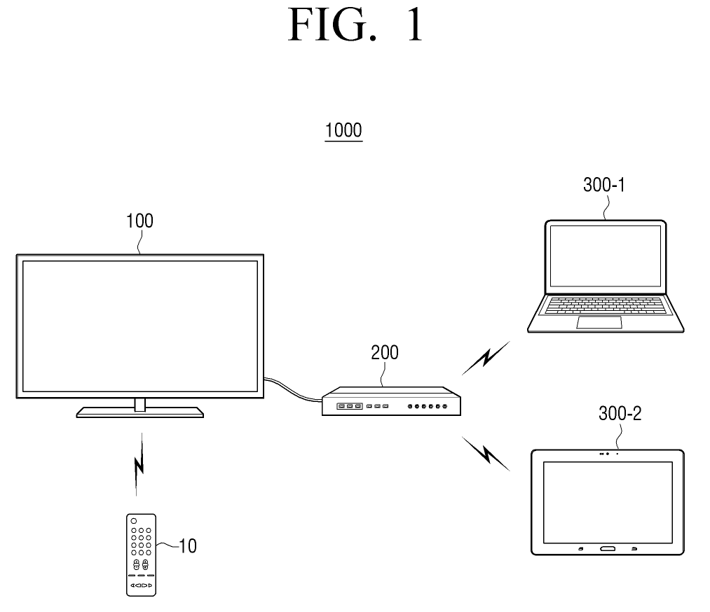

FIG. 1 is a diagram illustrating an electronic system according to an exemplary embodiment.

Referring to FIG. 1, an electronic system 1000 includes an electronic device 100, an interface device 200, and peripheral devices 300-1 and 300-2.

The electronic device 100 can receive a remote control signal (or a control signal) from the remote control device 10 of the peripheral device. For example, the electronic device 100 may be a TV, a desktop computer, a digital signage, an electronic board, a kiosk, or the like. The remote control device 10 may be a remote control, a mobile device, a smartphone, a tablet computer, etc. The remote control device 10 may be a multi-purpose or universal remote control device 10 capable of controlling all of a plurality of peripheral devices and may be a dedicated remote control device 10 corresponding to one of the peripheral devices. The remote control signal may be an infrared (IR) signal. The remote control signal may be transmitted from the remote control device 10 to the electronic device 100 on a carrier frequency.

The electronic device 100 may be coupled to the interface device 200. The electronic device 100 and the interface device 200 may be connected by wire or wirelessly. The interface device 200 may include a terminal that can be connected to various external devices. For example, the interface device 200 may be a jack pack (i.e., selector switch box). The interface device 200 may include a Universal Serial Bus (USB) terminal, an High-Definition Multimedia Interface (HDMI) terminal, a Digital Visual Interface (DVI) terminal, an audio jack, a component-in terminal, a composite-in terminal, an optical terminal, a local area network (LAN) terminal, an RS-232 terminal, and an AUX terminal. The interface device 200 may include some of the terminals described above, and may further include a terminal in addition to the terminal described above.

The electronic device 100 may include only a power interface for receiving power and a communication interface for communication with the interface device 200. In other words, the electronic device 100 may not include an external device interface for transmitting/receiving data directly with the peripheral device. Instead, the electronic device 100 may interface with an external device via the interface device 200.

The electronic device 100 may transmit the remote control signal received from the remote control device 10 to the interface device 200. The remote control signal received from the remote control device 10 is a signal carried on the carrier frequency. The electronic device 100 may transmit a remote control signal carried on the carrier frequency to the interface device 200. The electronic device 100 may process the remote control signal carried on the carrier frequency before transmitting to the interface device 200. However, the electronic device 100 may not perform a demodulation process that removes the carrier frequency. The detailed procedure will be described below.

The interface device 200 may transmit a remote control signal carried on the carrier frequency to the peripheral devices 300-1 and 300-2. The interface device 200 may transmit a remote control signal to one or more of the peripheral devices 300-1 and 300-2. The peripheral devices 300-1 and 300-2 may receive a remote control signal. The remote control signal may be transmitted on the carrier frequency. Some peripheral devices among the peripheral devices 300-1 and 300-2 may not process the remote control signal because they are not the frequencies corresponding to their own carrier frequencies even if they receive the remote control signals carried on the carrier frequency. Alternatively, some peripheral devices may perform the demodulation process and may not process the remote control signal because the information contained in the remote control signal is information that is not pertinent to the peripheral device that receives the signal. Therefore, only the peripheral device corresponding to the transmitted remote control signal can perform the corresponding operation by demodulating the remote control signal.

All of the remote control signals for controlling the peripheral device can be received by the electronic device 100 and transmitted to the peripheral device. Therefore, even if the peripheral devices 300-1 and 300-2 are far away from the electronic device 100 or the peripheral devices 300-1 and 300-2 are hidden away inside a piece of furniture (e.g., shelf, media cabinet, storage, etc.) and are not exposed to the outside, the peripheral device can be controlled by inputting a remote control signal for controlling the peripheral device toward the electronic device 100.

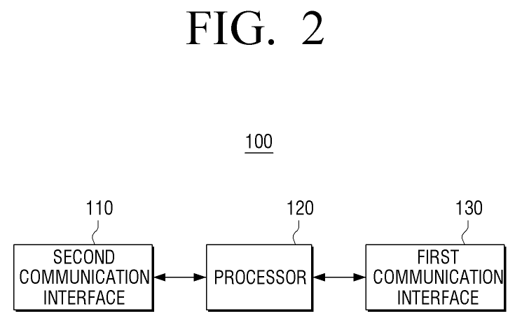

FIG. 2 illustrates a block diagram of an electronic device according to an exemplary embodiment.

As shown in FIG. 2, the electronic device 100 may include a second communication interface 110, a processor 120, and a first communication interface 130.

The second communication interface 110 may receive a remote control signal for controlling an external peripheral device from the remote control device. The remote control device may be a separate remote control device for controlling a specific peripheral device, and may be a multi-purpose universal remote control device capable of controlling multiple peripheral devices. The remote control device may transmit a remote control signal for controlling the peripheral device to the electronic device 100. The remote control signal may be transmitted on the carrier frequency. The remote control device may transmit the remote control signal using various carrier frequencies according to the peripheral device. For example, the carrier frequency may be in the range of 30 kHz to 57 kHz. The second communication interface 110 may receive a remote control signal on the carrier frequency transmitted from the remote control device. In one embodiment, the remote control signal may be an IR signal and the second communication interface 110 may include an IR receiving module.

The processor 120 may control the first communication interface 130 to transmit the remote control signal received at the received carrier frequency to the interface device when the remote control signal received at the carrier frequency is received from the remote control device through the second communication interface.

The first communication interface 130 may establish a connection between the electronic device 100 and an interface device for interfacing with external peripheral devices. The first communication interface 130 may connect the electronic device 100 with the interface device by wire or wirelessly. In one embodiment, the first communication interface 130 may be a wired communication interface capable of exchanging data through an optical cable, a copper wire, or the like. Alternatively, the first communication interface 130 may communicate through Bluetooth™, Infrared Data Association (IrDA), Ultra Wideband (UWB), ZigBee, Wi-Fi, USB, Digital Living Network Alliance (DLNA), and the like.

In general, an electronic device may perform demodulation when receiving a remote control signal from a remote control device. The electronic device may remove the carrier frequency through a demodulation process, perform a digital calculation process, and then perform a modulation process again. The electronic device may transmit the remote control signal to the corresponding peripheral device by loading the remote control signal at the carrier frequency through the modulation process. Thus, because a typical electronic device performs a demodulation and modulation process, a delay may occur by the time an electronic device receives a remote control signal and transmits it to a peripheral device. In addition, because a typical electronic device loads a remote control signal at a carrier frequency again after removing a carrier frequency, a remote control signal transmitted to a peripheral device may be distorted.

However, the electronic device 100 described in exemplary embodiments of the present disclosure may transmit the received remote control signal to the peripheral device via the interface device while being carried on the carrier frequency. Accordingly, because the electronic device 100 does not need to perform demodulation and modulation, the remote control signal can be quickly transmitted to the peripheral device, and the remote control signal is not distorted.

The specific procedure for transmitting a remote control signal will be described below.

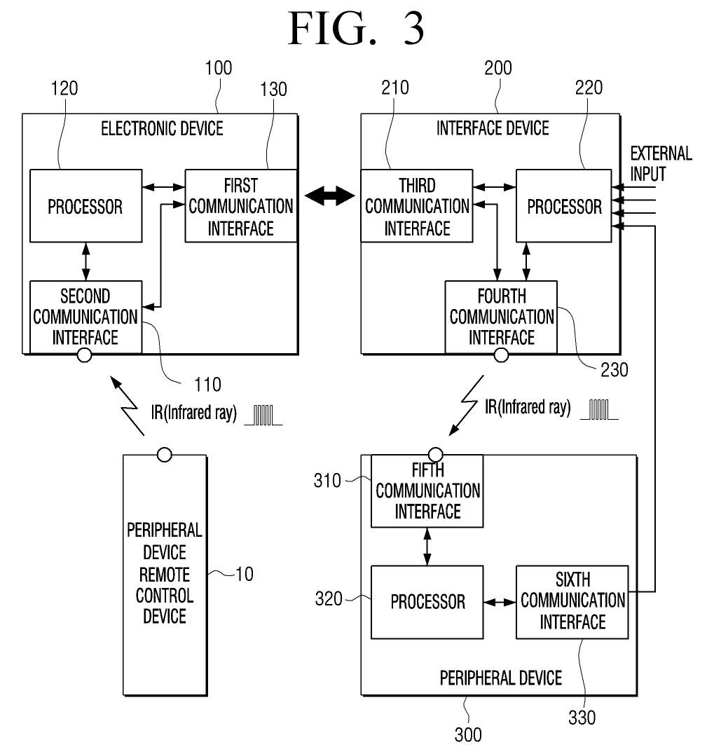

FIG. 3 is a diagram illustrating an electronic system according to an exemplary embodiment.

In FIG. 3, a peripheral remote control device 10, an electronic device 100, an interface device 200, and a peripheral device 300 are shown. The user may input a control command for controlling the peripheral device 300 through the peripheral device remote control device 10. The peripheral device remote control device 10 may transmit the remote control signal to the electronic device 100 in accordance with the input control command. The remote control signal may be transmitted to the electronic device 100 on a carrier frequency. Depending on the type of peripheral device, carrier frequencies of various frequency ranges may be used. For example, the carrier frequency may be in the range of 30 kHz to 57 kHz.

The electronic device 100 may include a second communication interface 110, a processor 120, and a first communication interface 130. The second communication interface 110 may receive a remote control signal transmitted at the carrier frequency transmitted from the peripheral device remote control device 10. For example, the second communication interface 110 may include an IR receiving module. Alternatively, the second communication interface 110 may include a wide band type module to receive remote control signals of various bands.

The processor 120 may control the first communication interface 130 to transmit a received remote control signal that does not have the carrier frequency removed to the interface device 200 when the remote control signal received at the carrier frequency is received from the remote control device 10.

The first communication interface 130 may connect the interface device 200 for interfacing with the peripheral device 300 and the electronic device 100, and may transmit a remote control signal to the interface device 200. The first communication interface 130 may be implemented as a wired communication interface or a wireless communication interface.

In one embodiment, the electronic device 100 may process the received remote control signal and transmit the processed remote control signal to the interface device 200. For example, the electronic device 100 may transmit the remote control signal to the interface device 200 by amplifying, removing noise from, or inverting the remote control signal.

The interface device 200 may include a third communication interface 210, a processor 220 and a fourth communication interface 230. The third communication interface 210 may receive the remote control signal from which the carrier frequency transmitted from the electronic device 100 is not removed.

The processor 220 may control the fourth communication interface 230 to transmit the received remote control signal to the peripheral device 300. The processor 220 may then control the third communication interface 210 to process or transmit an external input signal received via another input terminal to the electronic device 100.

The fourth communication interface 230 may be connected to the peripheral device 300 to transmit a remote control signal to the peripheral device 300. The fourth communication interface 230 may be implemented as a wired communication interface or a wireless communication interface. In one embodiment, the fourth communication interface 230 may include an IR transmission module. Accordingly, the interface device 200 can transmit the remote control signal through the fourth communication interface 230 to the peripheral device 300 in the form of an IR signal.

In one embodiment, the interface device 200 may process the received remote control signal and transmit it to the peripheral device 300. For example, the interface device 200 may invert, amplify, or perform noise cancellation on the remote control signal and transmit it to the peripheral device 300.

The peripheral device 300 may include a fifth communication interface 310, a processor 320, and a sixth communication interface 330.

The fifth communication interface 310 may receive the remote control signal transmitted from the interface device 200. According to an aspect of an exemplary embodiment, the fifth communication interface 310 may include an IR receiving module to receive a remote control signal in the form of an IR signal.

The processor 320 may process the received remote control signal. When the remote control signal is received on the carrier frequency used by the peripheral device 300, the processor 320 may perform signal processing to extract a control command from the remote control signal. When the extracted control command is a control command corresponding to the peripheral device 300, the processor 320 may perform a control function that corresponds to the control command. The processor 320 may ignore the control command if the extracted control command is a control command irrelevant to the peripheral device 300.

The peripheral device 300 may include a sixth communication interface 330. The sixth communication interface 330 may be connected to another external terminal of the interface device 200. The peripheral device 300 may transmit data to the electronic device 100 via the sixth communication interface 330.

The remote control signal input to the electronic device 100 through the above process may be transmitted to the peripheral device 300, and the peripheral device 300 may perform the control function. The electronic device 100 may process the received remote control signal and transmit it to the interface device 200.

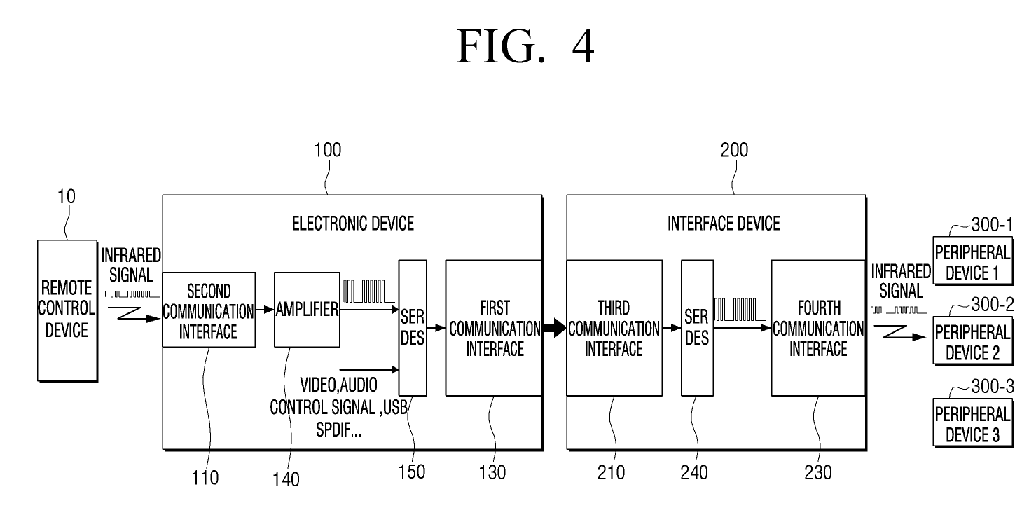

FIG. 4 is a diagram illustrating a process of transmitting a remote control signal according to an exemplary embodiment.

In FIG. 4, a remote control device 10, an electronic device 100, an interface device 200, and a plurality of peripheral devices 300-1, 300-2, and 300-3 are shown. The remote control device 10 may transmit the remote control signal carried on the carrier frequency to the electronic device 100. According to an aspect of an exemplary embodiment, the remote control signal may be an IR signal.

The electronic device 100 may receive a remote control signal via the second communication interface 110. An amplifier 140 of the electronic device 100 may amplify the remote control signal whose carrier frequency has not been removed. The amplified remote control signal may be transmitted to the interface device 200 through the first communication interface 130 of the electronic device 100. Because a typical electronic device removes the carrier frequency from the received remote control signal, it may be difficult to restore the carrier frequency when the electronic device transmits to the peripheral device. Therefore, a conventional electronic device can recover only a carrier frequency in a specific frequency band. In contrast, because the electronic device 100 transmits the carrier frequency component to the peripheral device through the interface device 200, the remote device signal transmitted at the carrier frequency of all the frequency bands may be transmitted to the peripheral device.

Alternatively, the electronic device 100 may include a serializer/deserializer 150. The serializer/deserializer 150 may convert the remote control signal, from which the carrier frequency has not been removed, to a serial signal, and may transmit the converted signal to the interface device 200 through the first communication interface 130. The serializer/deserializer 150 may process the remote control signal received from the remote control device 10 and the signal generated by the electronic device 100 together, convert them into a serial signal, and transmit them to the peripheral devices 300-1, 300-2, and 300-3 via the interface device 200.

According to an aspect of an exemplary embodiment, the processor of the electronic device 100 may sample the amplified remote control signal according to a certain criterion, and the serializer/deserializer 150 may convert the sampled signal to a serial signal together with the signal generated by the electronic device 100, and transmit the resulting signal to the interface device 200. For example, the signal generated in the electronic device 100 may be a video signal, an audio signal, a USB data signal, a Sony Philips Digital Interface (SPDIF) signal, and/or a control signal output from the electronic device.

Meanwhile, the electronic device 100 may further include a filter to remove noise from the remote control signal. Alternatively or additionally, the electronic device 100 may include a signal inversion module to invert the phase of the remote control signal by 180 degrees.

The interface device 200 may receive the serial-converted signal from the electronic device 100 via the third communication interface 210. For example, the serialized signal may be a remote control signal with no carrier frequency removed. The remote control signal without the carrier frequency removed may be an amplified signal. Alternatively, the serialized signal may include a remote control signal from which the carrier frequency has not been removed and a signal generated by the electronic device 100.

A serializer/deserializer 240 of the interface device 200 may restore the serial-converted signal received from the electronic device 100 back to the original signal. Alternatively, the serializer/deserializer 240 may separate the serial-converted signals received from the electronic device 100 into respective signals.

The fourth communication interface 230 of the interface device 200 may transmit a remote control signal, from which the carrier frequency is not removed via the serial/deserializer 240, to at least one of the peripheral devices 300-1, 300-2, and 300-3. In one embodiment, the fourth communication interface 230 of the interface device 200 may include an IR transmission module to transmit a remote control signal in the form of an IR signal.

Meanwhile, the interface device 200 may further include a signal inversion module to invert the phase of the remote control signal by 180 degrees. Alternatively or additionally, the interface device 200 may include a filter to remove noise from the remote control signal.

The peripheral devices 300-1, 300-2, and 300-3 may determine whether the signals are the remote control signals corresponding to the carrier frequency or the remote control signal using the information included in the carrier frequency or the remote control signal, to perform a control command included in the remote control signal.

Because the electronic system does not go through the modulation/demodulation process or the digital computing device, the time delay due to the remote control signal transmission may be minimized.

On the other hand, an electronic system including the electronic device 100 of the present disclosure can minimize the influence of multipath.

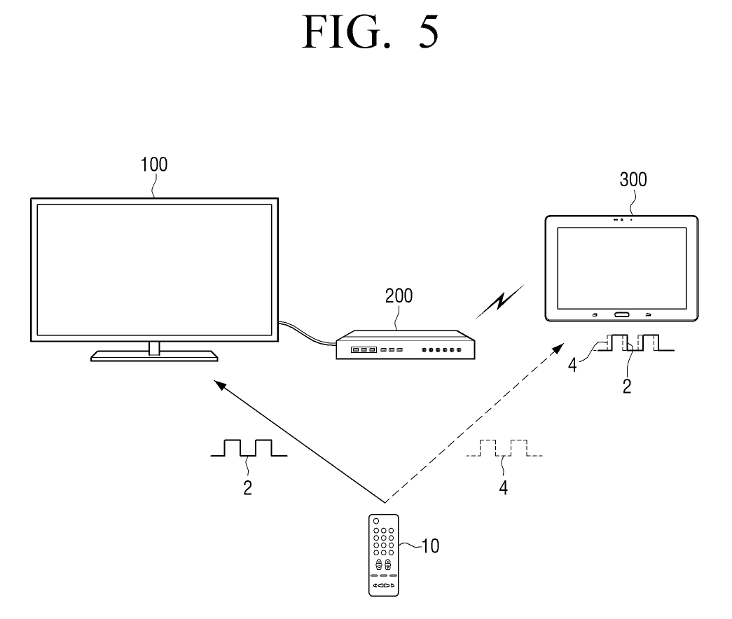

FIG. 5 illustrates a multipath effect of a remote control signal according to an exemplary embodiment.

In FIG. 5, a remote control device 10, an electronic device 100, an interface device 200, and a peripheral device 300 are shown. The multi-path means that one transmission signal is transmitted to a receiving side through a plurality of paths due to direct and indirect transmissions. Because the same signal is transmitted over a plurality of paths, multipath can cause a malfunction on the receiving side.

As shown in FIG. 5, the electronic device 100 and the peripheral device 300 may be located in the same space (e.g., same room). The remote control signal may be transmitted from the remote control device 10 to the electronic device 100 but may also be directly transmitted to the peripheral device 300 in the same space. The remote control device 10 transmits the remote control signal 2 to the electronic device 100. The electronic device 100 transmits the remote control signal 2 to the interface device 200 through the process described above and the interface device 200 transmits the remote control signal 2 to the peripheral device 300. That is, the remote control signal 2 transmitted from the remote control device 10 may be transmitted to the peripheral device 300 through the first path passing through the electronic device 100 and the interface device 200. Meanwhile, the remote control signal 4 transmitted from the remote control device 10 may be directly transmitted to the peripheral device 300 through the second path. A time difference may occur between the remote control signal 2 transmitted on the first path received by the peripheral device 300 and the remote control signal 4 transmitted on the second path.

Because a conventional electronic device performs signal processing such as demodulation and demodulation on a remote control signal, it may take a long time to be transmitted to a peripheral device. Therefore, the time difference between the remote control signal of the first path and the remote control signal of the second path passing through the general electronic device can be large. Accordingly, the peripheral device cannot decipher the remote control signal of the first path due to the interference of the remote control signal of the second path, causing the peripheral device to operate incorrectly or malfunction.

However, the electronic device 100 need not perform signal processing such as demodulation/demodulation on the remote control signal 2 of the first path. Therefore, the time difference from the remote control signal 4 of the second path may be reduced or essentially eliminated (i.e., the delay is too small to cause any erratic behavior). Accordingly, the peripheral device 300 may interpret the remote control signal 2 of the first path with ease, thereby preventing any incorrect operations or malfunctions.

Various exemplary embodiments of electronic systems including electronic devices have been described so far. Hereinafter, a flowchart of the electronic device control method will be described.

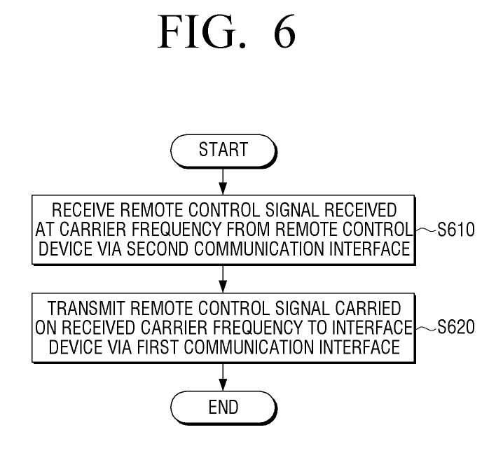

FIG. 6 is a flowchart of an electronic device control method according to an exemplary embodiment.

As shown in FIG. 6, the electronic device may receive a remote control signal received at a carrier frequency from a remote control device through a second communication interface, at operation S610. The electronic device may include a first communication interface connected to an interface device for interfacing with an external peripheral device and a second communication interface receiving a remote control signal for controlling an external peripheral device from the remote control device. The remote control device may be dedicated remote control device that controls a specific peripheral device, or may be universal remote control device that controls multiple peripheral devices. The carrier frequency may be a frequency in the range of 30 kHz to 57 kHz.

The electronic device may further include an amplifier to amplify the remote control signal received via the second communication interface and to transmit the amplified signal to the interface device via the first communication interface. The electronic device may further include a serializer/deserializer, convert the amplified signal into a serial signal, and transmit the converted serial signal to the interface device through the first communication interface. The electronic device may convert other signals together with the remote control signal into a serial signal. For example, the other signal may be a video signal, an audio signal, a USB data signal, a SPDIF signal, or a control signal output from the electronic device. The electronic device may further include a filter to remove noise from the remote control signal, and may further include a signal inversion module to invert the phase of the remote control signal by 180 degrees.

The electronic device may transmit a remote control signal carried on the received carrier frequency to the interface device via the first communication interface, at operation S620. The interface device can transmit the remote control signal to the peripheral device. The interface device may further include a serializer/deserializer corresponding to the electronic device to convert the received serial signal into a parallel signal. Also, the interface device may further include a signal inversion module to invert the phase of the remote control signal by 180 degrees, and the interface device may further include a filter to remove noise of the remote control signal.

In some exemplary embodiments, the electronic device control method may be implemented as a program and stored in a non-transitory computer readable medium.

The non-transitory computer readable medium refers to a medium that stores data permanently or semi-permanently rather than storing data for a very short time, such as a register, a cache, a memory or etc., and is readable by an apparatus. These various applications or programs may be provided in a non-transitory computer readable medium such as a compact disc (CD), digital versatile disc (DVD), hard disk, Blue-ray disc, memory card, and read-only memory (ROM), etc.

As described above, according to various exemplary embodiments, the electronic system, the electronic device, and the control method can receive the control signal of the peripheral device from the electronic device and transmit the received control signal to the peripheral device.

Further, according to various exemplary embodiments, the electronic system, the electronic device, and the control method may transmit the control signal to the peripheral device even if the peripheral device is remotely located or shielded.

Further still, according to various exemplary embodiments, the electronic system, the electronic device, and the control method may transmit the remote control signals of various frequency bands without delay time.

In addition, according to various exemplary embodiments, the electronic system, the electronic device, and the control method may minimize the distortion of the control signal of the peripheral device, quickly transmit the control signal to the peripheral device, and prevent malfunctions.

While exemplary embodiments have been shown and described, it will be understood by those skilled in the art that various changes in form and details may be made therein without departing from the spirit and scope of the inventive concept as defined by the appended claims and their equivalents.

What is claimed is:

1. An electronic device comprising:
a first communication interface configured to connect the electronic device to an interface device for interfacing with an external peripheral device;
a second communication interface configured to receive a remote control signal for controlling the external peripheral device from a remote control device; and
a processor configured to, in response to the remote control signal at a carrier frequency being received from the remote control device via the second communication interface, control the first communication interface to transmit the received remote control signal at the carrier frequency to the interface device.

2. The electronic device as claimed in claim 1, further comprising an amplifier configured to amplify the remote control signal received via the second communication interface,
wherein the processor is further configured to control the first communication interface to transmit the remote control signal amplified by the amplifier to the interface device.

3. The electronic device as claimed in claim 2, further comprising a serializer/deserializer configured to convert the amplified signal into a serial signal,
wherein the processor is further configured to control the first communication interface to transmit the serial signal converted by the serial/deserializer to the interface device.

4. The electronic device as claimed in claim 3, wherein the serializer/deserializer is further configured to process at least one of a video signal, an audio signal, a Universal Serial Bus (USB) data signal, a Sony Philips Digital Interface (SPDIF) signal, and a control signal output from the electronic device, together with the amplified signal, and convert the processed signal into the serial signal.

5. The electronic device as claimed in claim 1, wherein the carrier frequency is in a range of 30 kHz to 57 kHz.

6. The electronic device as claimed in claim 1, wherein the first communication interface is a wired communication interface configured to communicate via an optical cable.

7. A controlling method of an electronic device, the method comprising:
connecting, via a first communication interface of the electronic device, the electronic device to an interface device for interfacing with an external peripheral;
receiving, via a second communication interface of the electronic device, a remote control signal at a carrier frequency from a remote control device for controlling the external peripheral device; and
transmitting, via the first communication interface, the received remote control signal at the carrier frequency to the interface device.

8. The controlling method as claimed in claim 7, further comprising amplifying the remote control signal received via the second communication interface,
wherein the transmitting comprises transmitting, via the first communication interface, the amplified signal to the interface device.

9. The controlling method as claimed in claim 8, further comprising converting the amplified signal into a serial signal,
wherein the transmitting comprises transmitting, via the first communication interface, the converted serial signal to the interface device.

10. The controlling method as claimed in claim 9, wherein the converting comprises processing at least one of a video signal, an audio signal, a Universal Serial Bus (USB) data signal, a Sony Philips Digital Interface (SPDIF) signal, and a control signal output from the electronic device, together with the amplified signal, and converting the processed signal into the serial signal.

11. The controlling method as claimed in claim 7, wherein the carrier frequency is in a range of 30 kHz to 57 kHz.

12. An electronic system comprising:
an electronic device; and
an interface device configured to interface with the electronic device and an external peripheral device,
wherein the electronic device comprises:
a first communication interface configured to connect the electronic device to the interface device,
a second communication interface configured to receive, from a remote control device, a remote control signal for controlling the external peripheral device, and
a processor configured to, in response to the remote control signal at a carrier frequency being received from the remote control device via the second communication interface, control the first communication interface to transmit the received remote control signal at the carrier frequency to the interface device, and
wherein the interface device is further configured to transmit the remote control signal received from the electronic device to the external peripheral device.
